(19) United States
(12) Patent Application Publication
(10) Pub. No.: US 2023/0128737 A1
(43) Pub. Date: Apr. 27, 2023

(54) Solar Panel and Kinetic Energy Charging Phone Case

(71) Applicant: Edward Jackson, Elk Grove, CA (US)

(72) Inventor: Edward Jackson, Elk Grove, CA (US)

(21) Appl. No.: 17/509,893

(22) Filed: Oct. 25, 2021

(51) Int. Cl. H02J 7/00; H02J 3/38; F16M 13/00

(52) U.S. Cl. CPC H02J 7/0044; H02J 3/381; F16M 13/005; H02J 2300/24; H02J 2300/40; H02J 2310/22

(57) ABSTRACT

The Solar Panel and Kinetic Energy Charging Phone Case will charge a phone or tablet through solar panels on the back of the case or through movement. The solar panel on the back of the case provides a charge for the phone or attached electronic device. The electronic device connected to the Solar Panel and Kinetic Energy Charging Phone Case can also be charged through kinetic energy, which is monitored by the phone's accelerometer. The case-charging attachment to the phone connects to all phone charging ports, such as through USB-C, Micro-USB, and Lightning. Attached to the case are two folding bars, which can be used to hold the phone up on a flat surface, such as a table. The case itself is also waterproof and available in different colors and materials.

### BACKGROUND

A solar cell, or photovoltaic cell, is an electrical device that converts the energy of light directly into electricity by the photovoltaic effect, which is a physical and chemical phenomenon. It is a form of photoelectric cell, defined as a device whose electrical characteristics, such as current, voltage, or resistance, vary when exposed to light. Individual solar cell devices are often the electrical building blocks of photovoltaic modules, known colloquially as solar panels. Solar cells are described as being photovoltaic, irrespective of whether the source is sunlight or an artificial light. In addition to producing energy, they can be used as a photodetector (for example infrared detectors), detecting light or other electromagnetic radiation near the visible range, or measuring light intensity.

Human-powered equipment is occasionally used to generate, and sometimes to store, electrical energy for use where no other source of power is available. These include the Gibson girl survival radio, wind-up or (clockwork) radio and pedal radio. Human power is work or energy that is produced from the human body. It can also refer to the power (rate of work per time) of a human. Power comes primarily from muscles, but body heat is also used to do work like warming shelters, food, or other humans.

### SUMMARY OF THE INVENTION

The Solar Panel and Kinetic Energy Charging Phone Case will charge a phone or tablet through solar panels on the back of the case. The solar panel on the back of the case provides a charge for the phone or attached electronic device. Any light that shines onto that panel will be used to charge the device. Depending on the size of the phone and case, the panel will be two inches shorter by height and one inch shorter by length. The case-charging attachment to the phone connects to all phone charging ports, such as through USB-C, Micro-USB, and Lightning. Attached to the case are two folding bars, which can be used to hold the phone up on a flat surface, such as a table. The case itself is also waterproof and available in different colors and materials.

The electronic device connected to the Solar Panel and Kinetic Energy Charging Phone Case can also be charged through kinetic energy, which is monitored by the phone's accelerometer.

In one disclosure, the case is combined with a phone battery to integrate the solar and kinetic charging directly into the phone. Instead of using a battery that would be built into the device, the battery will be replaced with the phone case directly connected to the electronic device.

A cell phone case including a charging port configured to provide an electrical connection to a cell phone in the case and an external power source connection to the cell phone. The disclosure also includes a plurality of solar cells configured to generate electricity from an external surface of the cell phone case and electrically connect to the charging port. The disclosure additionally includes a kinetic energy generator configured to generate electricity and integrate with the cell phone case and electrically connect to the charging port. Furthermore, the disclosure includes a battery configured to store the electricity from the plurality of solar cells and the kinetic energy generator and connect to the charging port

### BRIEF DESCRIPTION OF THE DRAWINGS

FIG. 1 is a front view of the charging phone case without an attached electronic device in accordance with an embodiment of the present disclosure.

FIG. 2 is a left-side view of the charging phone case in accordance with an embodiment of the present disclosure.

FIG. 3 is a back view of the charging phone case in accordance with an embodiment of the present disclosure.

FIG. 4 is a right-side view of the charging phone case in accordance with an embodiment of the present disclosure.

FIG. 5 is a top view of the charging phone case in accordance with an embodiment of the present disclosure.

FIG. 6 is a bottom view of the charging phone case in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

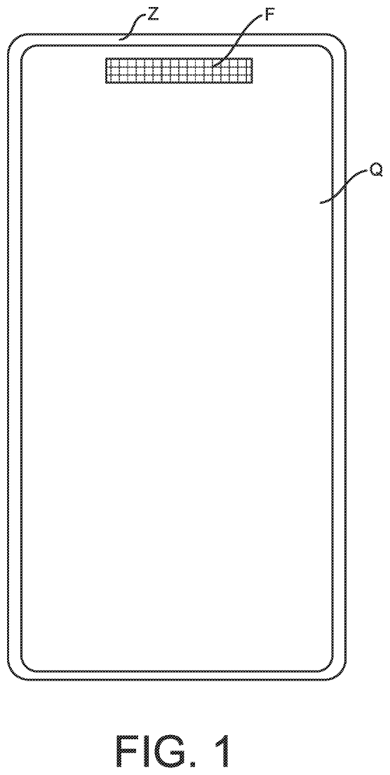

FIG. 1 is a front view of the charging phone case without an attached electronic device in accordance with an embodiment of the present disclosure.

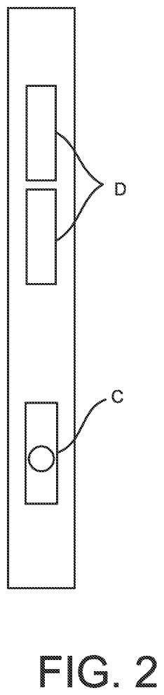

FIG. 2 is a left-side view of the charging phone case in accordance with an embodiment of the present disclosure.

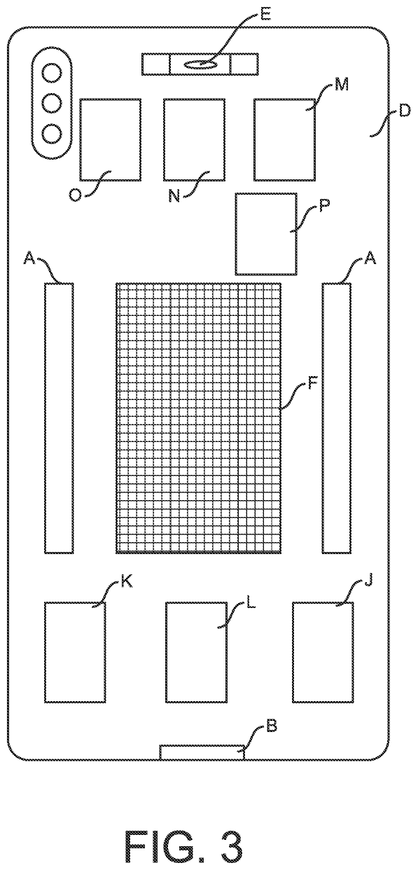

FIG. 3 is a back view of the charging phone case in accordance with an embodiment of the present disclosure.

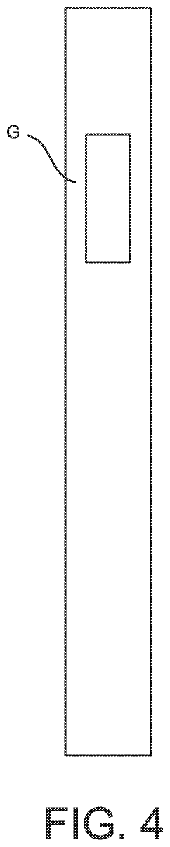

FIG. 4 is a right-side view of the charging phone case in accordance with an embodiment of the present disclosure.

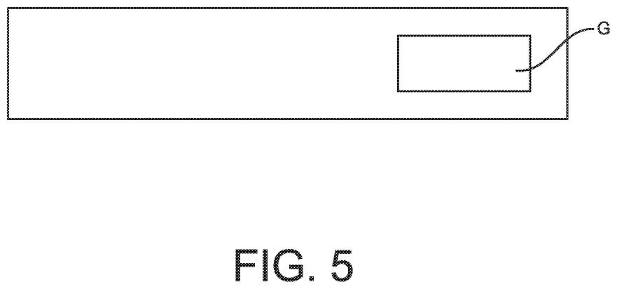

FIG. 5 is a top view of the charging phone case in accordance with an embodiment of the present disclosure.

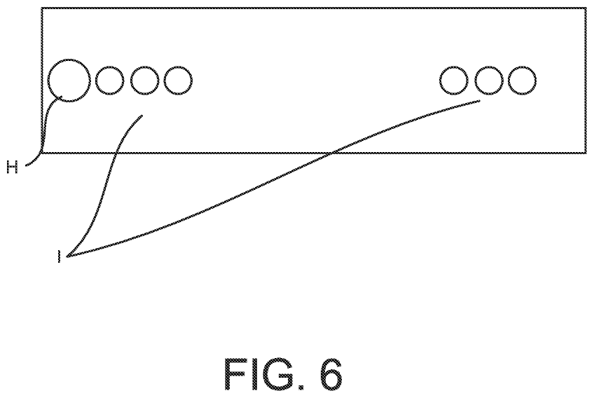

FIG. 6 is a bottom view of the charging phone case in accordance with an embodiment of the present disclosure.

Reference A depicts the case stands. Reference B depicts the built-in charging port that connects to the electronic device in the case. Reference C depicts the on and off switch for the phone case charging. Reference D depicts the electronic device's volume buttons, which are able to be pressed while the case is on the device. Reference E depicts the level bubble, which shows the orientation of the phone. Reference F depicts the solar panel on the case. Reference G depicts the electronic device's power button, which may be on the side or top of the case, depending on the phone model. Reference H depicts the hole for a headphone jack for the electronic device. Reference I depicts the holes in the case for the device's speakers. Reference J depicts the kinetic energy generator, reference K depicts the transformer, reference L depicts the current pump, reference M depicts the power multiplexer circuit, reference N depicts the battery, reference O depicts the control circuit and reference P depicts the accelerometer circuit and sensors.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A cell phone case comprising:
a charging port configured to provide an electrical connection to a cell phone in the case and an external power source connection to the cell phone;
a plurality of solar cells configured to generate electricity from an external surface of the cell phone case and electrically connect to the charging port;
a kinetic energy generator configured to generate electricity and integrate with the cell phone case and electrically connect to the charging port; and
a battery configured to store the electricity from the plurality of solar cells and the kinetic energy generator and connect to the charging port.

2. The cell phone case of claim 1, further comprising a transformer configured to transform the electricity from the plurality of solar cells and the kinetic energy generator into a cell phone electricity.

3. The cell phone case of claim 1, further comprising a bubble level configured to detect a movement of the cell phone case.

4. The cell phone case of claim 1, further comprising a pair of legs configured to fold out of the cell phone case and prop up the cell phone case at a viewing angle.

5. The cell phone case of claim 1, wherein the plurality of solar cells are disposed on an external front surface and an external back surface of the cell phone case.

6. The cell phone case of claim 1, wherein the plurality of solar cells cover the external surface of the cell phone case.

7. The cell phone case of claim 1, further comprising a cutout defined in the cell phone case for a headphone jack connection.

8. The cell phone case of claim 1, further comprising a plurality of control buttons defined in the cell phone case for volume control.

9. The cell phone case of claim 1, further comprising a plurality of cutouts for a cell phone camera.

10. The cell phone case of claim 1, further comprising a plurality of control buttons defined in the cell phone case for power and sim tray.

11. The cell phone case of claim 1, further comprising a plurality of cutouts for a plurality of speaker ports to the cell phone.

12. The cell phone case of claim 1, further comprising a current pump circuit configured to generate a current at a given voltage to power the cell phone.

13. The cell phone case of claim 1, wherein the battery is also configured to store an electricity from the external power source.

14. The cell phone case of claim 1, further comprising a control circuit configured to provide a battery level and a charging status thereof.

15. The cell phone case of claim 1, further comprising an accelerometer circuit configured to detect a relative movement of the cell phone case via differentiating a change in a velocity thereof.

16. The cell phone case of claim 1, further comprising a multiplexer circuit configured to decide one of the cell phone case battery and a cell phone battery as a power source.

17.

18.

19.

20.
